(19) United States
(12) Patent Application Publication
(10) Pub. No.: US 2015/0143412 A1
(43) Pub. Date: May 21, 2015

(54) CONTENT PLAYBACK CONTROL DEVICE, CONTENT PLAYBACK CONTROL METHOD AND PROGRAM

(71) Applicant: CASIO COMPUTER CO., LTD., Shibuya-ku, Tokyo (JP)

(72) Inventors: Takashi Shibuya, Tama-shi (JP); Katsuyuki Shibata, West New York, NJ (US); Ken Yoshino, Koganei-shi (JP)

(73) Assignee: CASIO COMPUTER CO., LTD., Shibuya-ku, Tokyo (JP)

(21) Appl. No.: 14/411,381

(22) PCT Filed: Jun. 21, 2013
(86) PCT No.: PCT/JP2013/003911

§ 371 Date: Dec. 24, 2014

(30) Foreign Application Priority Data
Jun. 29, 2012 (JP) 2012-147648

(51) Int. Cl. H04N 21/439; H04N 21/81; H04N 21/422; H04N 21/441; H04N 21/4223

(52) U.S. Cl. CPC H04N 21/4394; H04N 21/441; H04N 21/4223; H04N 21/42203; H04N 21/8106; H04N 21/812
USPC 725/34

(57) ABSTRACT

A content playback control device includes: an acquirer for acquiring an attribute of a listener that is the target of providing content; a determiner for determining a language when playing back the content, based on the attribute of the listener acquired by the acquirer; and a playback controller for playing back the content through audio in the determined language determined by the determiner.

### TECHNICAL FIELD

The present invention relates to a content playback control device, a content playback control method and a program therefor.

### BACKGROUND ART

In order to be more impressive when presenting content such as advertising content and/or the like to a listener, art has been conceived that projects, on a screen formed in a human shape, content video having a shape matching the screen contours, such as in the invention disclosed in Patent Literature 1.

### CITATION LIST

### Patent Literature

[PTL 1]
Unexamined Japanese Patent Application Kokai Publication No. 2011-150221

### SUMMARY OF INVENTION

### Technical Problem

The art disclosed in the above-described Patent Literature 1 is for making an announcement to the listener in the language of the prepared content, but it is difficult for a listener who cannot understand the language of that content to understand what information that content is explaining.

In consideration of the foregoing, it is an objective of the present invention to provide a content playback control device, a content playback control method and a program therefor for identifying a language understandable to the listener and playing back content in an easy-to-understand method using a language understandable to that listener.

### Solution to Problem

A first aspect of the present invention is a content playback control device for controlling playback of content, comprising: acquisition means for acquiring an attribute of a listener that is the target of providing content; determination means for determining a language when playing back the content, based on the attribute of the listener acquired by the acquisition means; and playback control means for playing back the content through audio in the determined language determined by the determination means.

A second aspect of the present invention is a content playback control method for controlling playback of content, comprising: an acquisition step for acquiring an attribute of a listener that is the target of providing content; a determination step for determining a language when playing back the content, based on the attribute of the listener acquired by the acquisition step; and a playback control step for playing back the content through audio in the determined language determined by the determination step.

A third aspect of the present invention is a program executed by a computer built into which is a device for controlling playback of content, the program causing the computer to function as: acquisition means for acquiring an attribute of a listener that is the target of providing content; determination means for determining a language when playing back the content, based on the attribute of the listener acquired by the acquisition means; and playback control means for playing back the content through audio in the determined language determined by the determination means.

### Advantageous Effects of Invention

With the present invention, it is possible to provide a content playback control device, a content playback control method and a program therefor for identifying a language understandable to a listener and playing back content in an easy-to-understand manner using a language understandable to that listener.

### BRIEF DESCRIPTION OF DRAWINGS

FIG. 1 is a summary drawing showing usage conditions for a system including a content playback control device according to one embodiment of the present invention.

FIG. 2 is a block diagram showing a summary composition of the functions of the content playback control device according to the embodiment.

FIG. 3 is a flowchart showing process contents for actions of the content playback control device according to the embodiment.

FIG. 4A is an example of a race-language table prepared in the memory device of the content playback control device according to the embodiment.

FIG. 4B is an example of a nationality-language table prepared in the memory device of the content playback control device according to the embodiment.

FIG. 5 is a flowchart explaining the playback content preparation process, out of the actions of the content playback control device according to the embodiment.

FIG. 6 is a drawing for explaining the action concept of selecting playback content corresponding to a determined language when there is content corresponding to that language, out of the actions of the content playback control device according to the embodiment.

FIG. 7 is a drawing for explaining the action concept of converting to playback content corresponding to a determined language when there is no content corresponding to that language, out of the actions of the content playback control device according to the embodiment.

### DESCRIPTION OF EMBODIMENTS

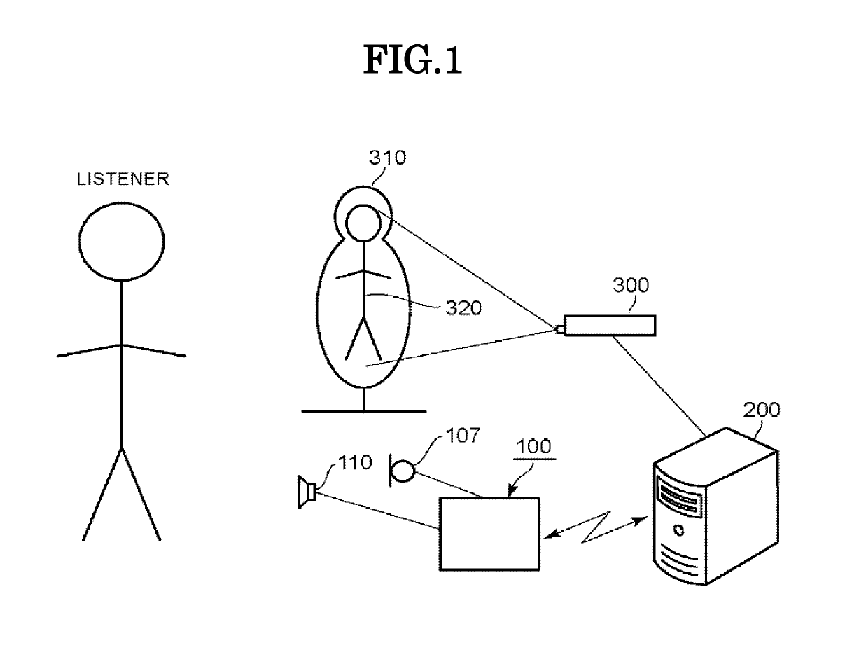

Below, a content playback control device according to one embodiment of the present invention is described with reference to the drawings. FIG. 1 is a summary drawing showing usage conditions for a system including a content playback control device 100 according to the embodiment of the present invention.

As shown in FIG. 1, the content playback control device 100 is connected to a server 200 that is a content supply device using, for example, wireless communications and/or the like, and the server 200 is connected to a projector 300 that is a content video playback device. A screen 310 is set up on the output light exposure direction side of this projector 300. The projector 300 projects, by output light, a human image video 320, for example, on the screen 310 as video of the content after receiving content supplied from the server 200.

The content playback control device 100 is provided with a microphone 107 and a speaker 110. The content playback control device 100 through this microphone 107 recognizes the sound (audio) of the listener's conversation and from the recognized audio determines the language being used in the conversation. Furthermore, the content playback control device 100 searches for content in the determined language from audio content recorded on the server 200, and supplies content in this language to the listener as audio using the speaker 110 (described in detail below).

The server 200 stores image content and audio content. Furthermore, the server 200 supplies content to the projector 300 and the content playback control device 100 based on commands from the content playback control device 100.

The projector 300 is, for example, a DLP (Digital Light Processing (registered trademark)) type of data projector using DMD (Digital Micromirror Device), and is a display element that, through a display action of individually turning on/off at high speed the angle of inclination of multiple, for example an XGA (eXtended Graphics Array, 1024 pixels wide by 768 pixels tall) number of, microscopic mirrors arranged in an array, forms optical images through the light reflected therefrom.

The screen 310 is formed of a resin board cut so as to take the shape of the projected content. A screen film for a rear-projection type of projector is adhered to the projection surface and has a function as a screen for rear projection. With this screen film, it is possible to visually confirm content projected onto the screen, even under the brightness of midday or in a bright room, by using film having high luminosity and high contrast performance.

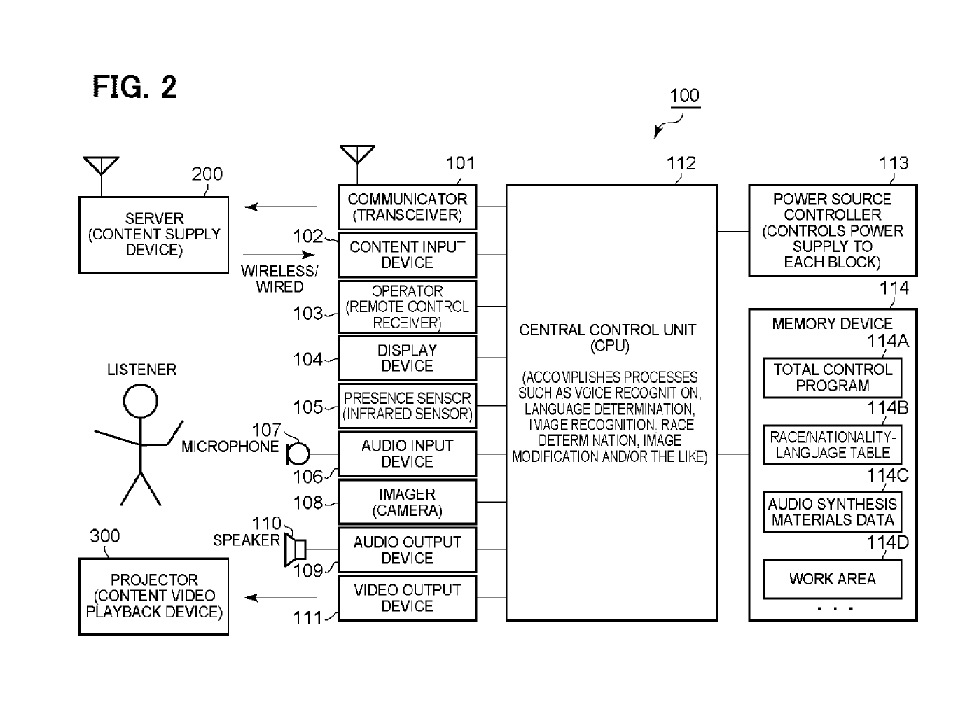

Next, the summary function composition of the content playback control device 100 according to the embodiment is explained with reference to FIG. 2.

In FIG. 2, a reference number 112 refers to a central control unit (CPU). This CPU 112 controls all of the actions of the content playback control device 100.

This CPU 112 is directly connected to a memory device 114. The memory device 114 stores a total control program 114A, a race-language table 114B and an audio synthesis materials data 114C and/or the like and also comprises a work area 114D.

The total control program 114A comprises an action program executed by the CPU 112 and various types of regular data, and/or the like.

The race/nationality-language table 114B is a table indicating a correlation between languages corresponding to the determined race/nationality of listener (described in detail below). The audio synthesis materials data 114C is data for audio synthesis materials used in creating text data of content translated into languages as an audio file of the appropriate format (described in detail below). The work data area 114D functions as a work memory for the CPU 112.

The CPU 112 reads the program and form data and/or the like stored in the aforementioned memory device 114, and controls the content playback control device 100 as a whole by developing that on the work area 114D and executing the program.

The aforementioned CPU 112 is further connected to an operator 103. The operator 103 receives a key operation signal from an unrepresented remote controller and/or the like and supplies this key operation signal to the CPU 112. The CPU 112 executes various actions such as turning on the power source, switching modes and/or the like in accordance with the operation signal from the operator 103.

The aforementioned CPU 112 is further connected to a display device 104. The display device 104 displays various operation statuses and/or the like corresponding to the operation signal from the operator 103.

The aforementioned CPU 112 is further connected to a communicator 101 and a content input device 102. The communicator 101 for examples uses wireless communications to send to the server 200 search commands and/or the like for searching whether or not desired content is in the content supply device 200, based on commands from the CPU 112. Naturally, it would be fine to send content search commands and/or the like to the server 200 using wire communications. The content input device 102 receives by wireless communication or wire communication content supplied from the server 200 and passes this content to the CPU 112.

The above-described CPU 112 is further connected to a presence sensor 105, an audio input device 106, an audio output device 109 and a video output device 111. The presence sensor 105 is an infrared sensor and/or the like, for example, and is a sensor for sensing whether or not the listener is within a prescribed range in front of the content playback control device 100. When the detected output from the presence sensor 105 is at least as great as a preset threshold value, the CPU 112 determines that the listener is within a prescribed range in front of the content playback control device 100.

The audio input device 106 is connected to the microphone 107. The audio input device 106 picks up sound surrounding the place where the content playback control device 100 is located using the microphone 107, and supplies the acquired sound to the CPU 112 as audio data. The audio output device 109 is connected to the speaker 110 and the audio output device 109 generates audio by converting an audio file supplied from the server 200 into actual audio using the speaker 110.

The video output device 111 supplies data on image content, out of the content supplied from the server 200, to the projector 300.

An imager 108 is further connected to the above-described CPU 112. The imager 108 shoots images around the content playback control device 100 in the angle of view of a prescribed range in front of the content playback control device 100 and supplies the acquired image data to the CPU 112.

The above-described CPU 112 further comprises a power source controller 113. The power source controller 113 controls power source supply to all of the constituent devices comprising the content playback control device 100 individually, and enacts control so that power conservation is appropriately achieved.

Next, the actions of the above-described the embodiment will be described. The actions indicated below are executed upon the CPU 112 developing in the work area 114D action programs and form data and/or the like read from a program memory 13A as described above. The action programs and/or the like stored as a total control program include not just those stored at the time this content playback control device 100 was shipped from the factory, but also contents the user installs through version upgrade programs and/or the like downloaded via the Internet from an unrepresented personal computer and/or the like via the communicator 101 after purchasing this content playback control device 100.

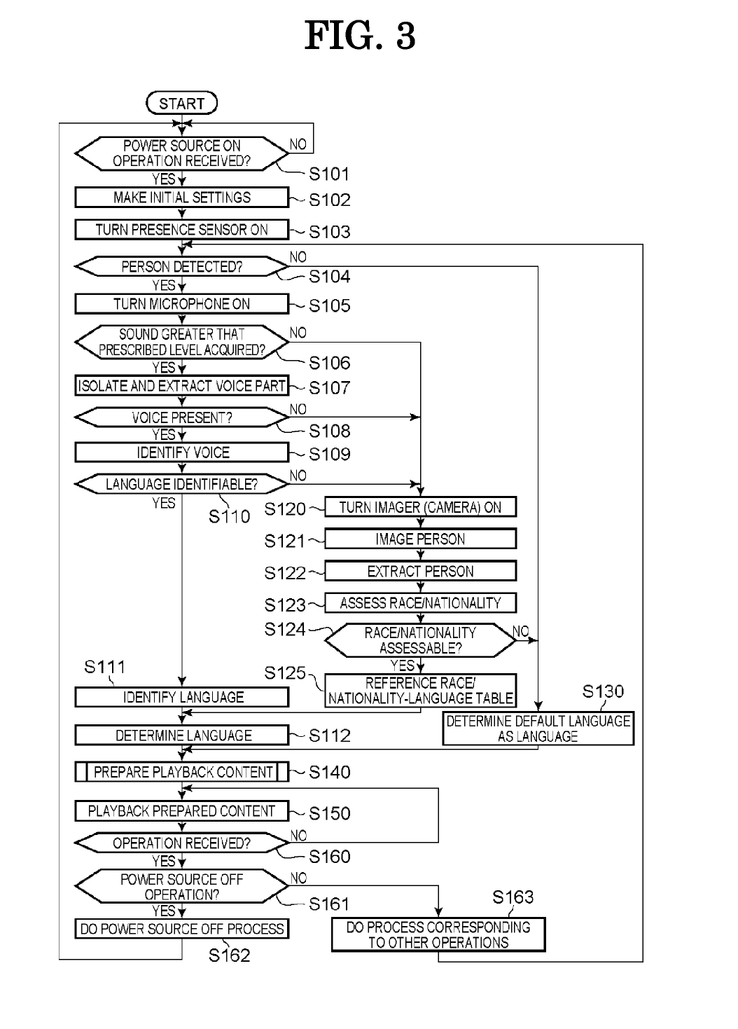

FIG. 3 is a flowchart showing the process contents for actions of the content playback control device 100 according to the embodiment. At the start of the action, the CPU 112 waits until there is a key operation from an unrepresented remote controller and/or the like that turns on the power source by means of the operator 3 (step S101). At this time, the CPU 112 causes the supply of power to circuits except those parts necessary for the power source to be turned on to be halted by the power source controller 113.

At the time that a key operation to turn the power source on is made with the remote controller, the CPU 112 determines this in the above-described step S101 and after executing a prescribed initial settings process (step S102), supplying of power to the presence sensor (infrared sensor and/or the like) 105 is started by the power source controller 113 (step S103).

Following this, the CPU 112 repeatedly determines whether the detection output from the presence sensor 105 is at least as great as a preset threshold value, and through this determines whether or not a person (listener) that is the target to which playback content should be provided is within a prescribed range in front of the content playback control device 100 (step S104). In step S104, when a person is not detected within a prescribed time, for example, the CPU 112 accomplishes the process of below-described step S130.

In step S104, when a person is sensed by the presence sensor 105, the CPU 112 instructs the power source controller 113 to start supplying power to the microphone 107 (step S105).

Furthermore, the CPU 112 determines whether or not sound at least as great as a prescribed level is acquirable by the microphone 107 in order to acquire information showing the listener's attributes (step S106). When sound at least as great as a prescribed level is not acquired within a prescribed time in step 106, the CPU 112 accomplishes the process of below-described step S120.

When it is determined that sound at least as great as a prescribed level has been acquired in step 106, the CPU 112 isolates and extracts from the acquired sound the part thought to be a human voice (step S107). This process may be accomplished by an existing algorithm such as frequency analysis and/or the like.

Furthermore, the CPU 112 determines whether or not the part thought to be a voice has been isolated and extracted (step S108). When it is determined in step S108 that the part thought to be a voice has not been isolated and extracted, the CPU 112 accomplishes the process of below-described step S120.

When it is determined in step S108 that there is a voice part, the CPU 112 accomplishes a detailed voice recognition process (step S109). This process may also be accomplished using an existing algorithm for voice recognition. As a result of voice recognition, the CPU 112 determines whether or not the language (English, Chinese, Japanese, and/or the like) of that voice is recognizable (step S110). When it is determined in step S110 that the language of the voice is not recognizable, the CPU 112 accomplishes the process of below-described step S120.

When it is determined in step S110 that the language is recognizable, the CPU 112 specifies that language (step S111) and determines the language used by the listener as the language when playing back content (step S112).

Next, an explanation is given for the processes from step S120, which is accomplished when sounds at least as great as a prescribed level are not acquired within a prescribed time in step S106, when it is determined in step S108 that there is no voice in the part isolated and extracted, and when it is determined in step S110 that the language of the voice is not recognizable. The processes from step S120 are processes for when it is determined that choosing a language through audio is impossible.

First, the CPU 112 instructs the power source controller 113 to begin supplying power to the imager 108 (step S120). Furthermore, the CPU 112 images an image of the person detected by the presence sensor within the angle of view of a prescribed range in front of the content playback control device 100 (step S121). At this time, imaging may be imaging as a still image, but imaging as video would also be fine.

Furthermore, the CPU 112 extracts the part thought to be a person from the captured image through image processing (step S122). Furthermore, the CPU 112 extracts characteristics such as the face, eye color, hair color, skin color, clothing and/or the like of that person and from those characteristics assesses the race (for example, Caucasian, black, Hispanic or Asian) or nationality (for example, American, Brazilian, French or Chinese) of the person (step S123).

Furthermore, the CPU 112 determines whether or not the race/nationality was assessed with a certain degree of certainty (step S124). When it is determined that the race/nationality could not be assessed in step S124, the CPU 112 accomplishes the process of below-described step S130.

When it is determined that race/nationality was assessed in step S124, the CPU 112 references the race/nationality-language table 114B stored in the memory device 114 (step S125) and determines a language corresponding to that race/nationality based on that race/nationality (step S112).

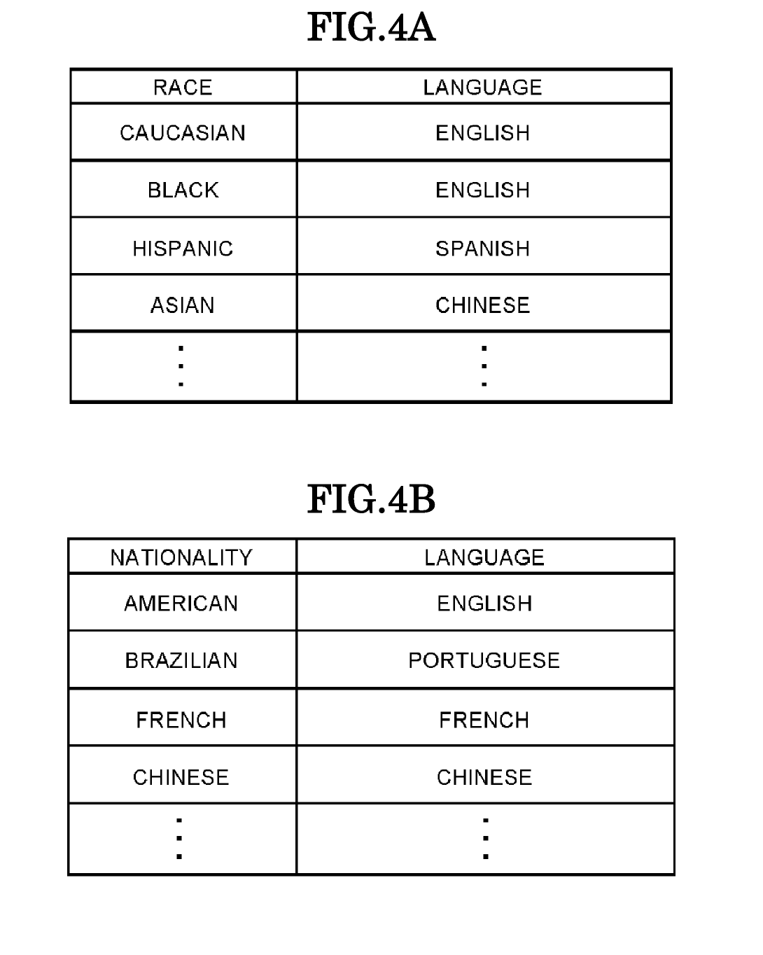

FIGS. 4A and 4B show examples of race/nationality-language tables, with FIG. 4A showing an example of a race-language table and FIG. 4B showing an example of a nationality-language table. For example, when the assessment from the image of the person is that the listener is Caucasian, the CPU 112 selects English as the language when playing back content. In addition, when the listener is assessed to be Brazilian from the image of the person, the CPU 112 selects Portuguese as the language when playing back content.

Next, the process of step S130, which as described above is accomplished when a target listener is not detected in step S104 or when it is determined in step S124 that race/nationality cannot be assessed, will be explained. The process of step S130 is a process for when specification of language cannot be accomplished.

In this case, the CPU 112 decides on a preset default language, for example English, as the language when playing back content (step S130).

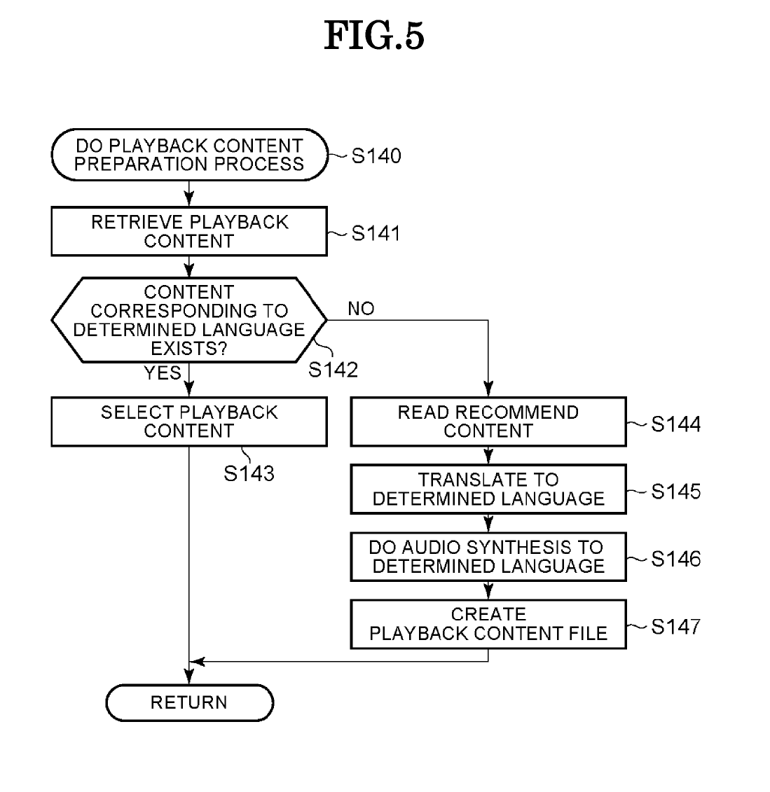

Next, the process from step S140, which is accomplished after the language for playing back content is determined in above-described step S112 or step S130, will be explained. Step S140 is a process for preparing playback content that has been determined, and will be explained with reference to FIG. 5.

In subroutine step S140, first the CPU 112 looks up whether or not content corresponding to the determined language is in the content supply device 200 (step S141).

A determination is made as to whether or not content corresponding to the determined language exists in the content supply device 200 (step S142), and when content corresponding to the determined language exists in the content supply device 200, the CPU 112 determines the playback content corresponding to that language (step S143).

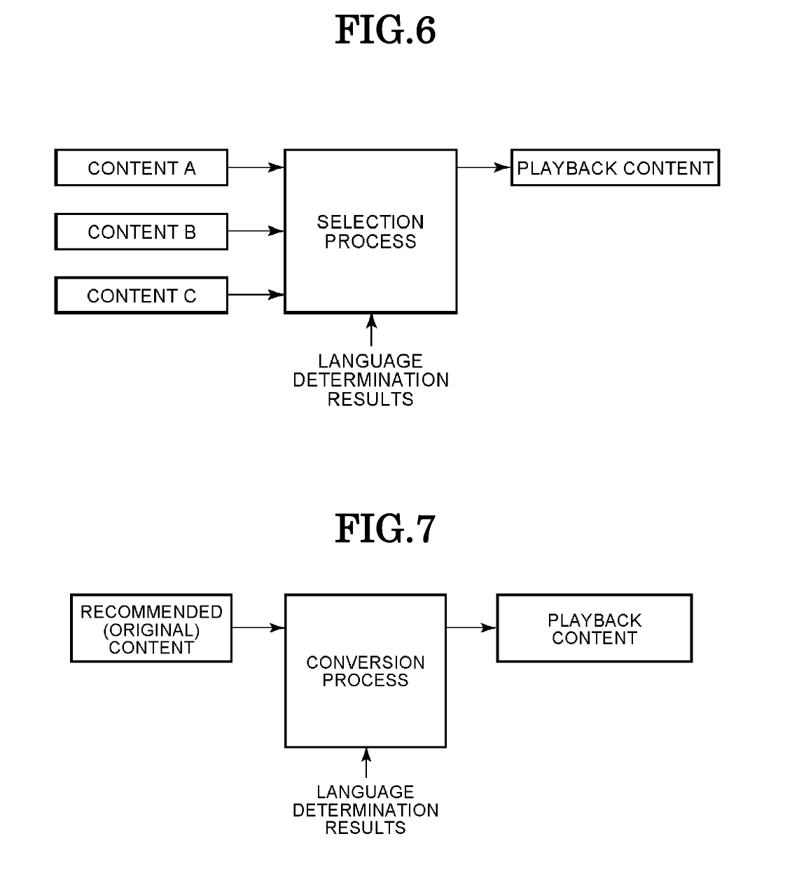

FIG. 6 shows an overview of the action at this time. Furthermore, exiting this subroutine, the process returns to the process of step S150 of FIG. 3.

In the subroutine step S142, when it is determined that content corresponding to the determined language does not exist in the content supply device 200, the CPU 112 reads recommended (first precedence) content from the content supply device 200 (step S144). At this time, the content that is read is preferably not an audio file but rather text data, but this depends on the content data format of the content supply device 200. When the content that is read is an audio file, it would be fine to accomplish a process converting such to text.

Next, the CPU 112 translates the content that was read into the determined language (step S145). The dictionary for translation used in this case may be one the content playback control device 100 has in the memory device 114. In addition, it would be fine to call an unrepresented external translation server through the communicator 101 and to accomplish translation using the dictionary of such. In addition, it would be fine for the translation server to be the content supply device 200.

Next, the CPU 112 synthesizes audio of the translated content using the audio synthesis materials data 114C stored in the memory device 114 (step S146). Furthermore, the CPU 112 creates a playback content file as an audio file to be played back in a suitable format (step S147).

FIG. 7 shows an overview of the actions of these steps S144-S147. Furthermore, upon exiting this subroutine the process returns to the process of step S150 in FIG. 3.

Next, the process after step S150, accomplished after exiting the above-described subroutine processes, will be explained. The CPU 112 outputs the content prepared by the above-described subroutine step S140 by the speaker 110 through the audio output device 109 (step S150).

At this time, when the content includes video, the CPU 112 outputs the video part of the prepared content to the content video playback device 300 such as a projector and/or the like and plays back so as to be synchronized with audio. For example, when synthesizing audio, the CPU 112 synthesizes audio so as to be in synchronous with video including movement of the mouth, and causes such as to be played back in synchronous. In addition, when synthesizing audio, it would be fine for the CPU 112 to correct video to be played back in synchronous with audio so as to be video suitable for the audio.

Furthermore, after accomplishing content playback, detection is made as to whether or not an operation was done on the operator 103 (step S160). When it is determined in step S160 that no operation was done, the CPU 112 returns to step S150 and repeats playback of the prepared content. In addition, it would be fine to set in advance the number of such repetitions.

When it is determined in step S160 that an operation was done, the CPU 112 determines whether or not that operation was a power-off operation (step S161). When it is determined in step S161 that the operation is a power-off operation, the CPU 112 accomplishes a prescribed power-off process (step S162) and the process then returns to the above-described step S101.

When it is determined in step S161 that the operation is not a power-off operation, the CPU 112 accomplishes a process corresponding to that operation (step S163) and the process then returns to the above-described step S104.

As described in detail above, with the above-described the embodiment, a language understandable by the listener is identified and content is played back using that language understandable by the listener, so it is possible to playback content in an easy-to-understand manner.

In addition, with the above-described the embodiment, when identifying a language understandable by the listener, sounds around the content playback control device 100 are acquired and a language thought to be spoken by the listener is identified, so a language understandable by the listener is easy to determine

Furthermore, with the above-described the embodiment, when identifying a language understandable by the listener, the surroundings of the content playback control device 100 are imaged, the race/nationality is decided as an attribute of the listener from the acquired video, and a language thought to be understandable by the listener is determined, so consequently it is possible to determine a language understandable by the listener even when determination based on audio is difficult.

In addition, with the above-described the embodiment, the above-described content playback control device 100 is provided with a presence sensor 105 and voice recognition is accomplished after detecting a person with the presence sensor 105. Through this, it is possible to prevent voice recognition with heavy processes from being accomplished in vain when no person is present. In addition, it is possible to easily detect whether or not a person is present even without accomplishing heavy processes such as image processing and/or the like by the imager 108. It would also be fine to accomplish voice recognition and/or an image recognition process without a presence sensor 105 being provided.

In addition, with the above-described the embodiment, first a language is determined through voice recognition and when a choice can be made, language determination through image recognition using the imager 108 need not be accomplished. Through this, it is possible to prevent image recognition with heavy processes by the imager 108 from being accomplished in vain.

In addition, with the above-described the embodiment, voice recognition was accomplished and when language recognition was difficult, image recognition using the imager 108 was accomplished, but it would also be fine to accomplish a process by the imager 108 in advance and determine the language through image recognition. In addition, it would also be fine to determine a language using only one of the recognition processes.

In addition, when the desire is to give priority to accuracy in language choice more than ease of processing, the language may be comprehensively determined by accomplishing both a process through voice recognition and a process through image recognition and using the results of both recognitions.

In addition, with the above-described the embodiment, even when, after identifying a language thought to be one the listener can understand, content in that language does not exist, the content is modified and played back, so it is possible to playback content so as to be understandable by the listener with certainty.

In addition, with the above-described the embodiment, when, after identifying a language thought to be one the listener can understand, content in that language exists, appropriate content is selected and played back, so it is possible to swiftly playback content understandable by the listener.

In addition, when content accompanies video, not only is selected/converted audio played back, but such is played back in synchronous with the video, and consequently it is possible to playback content understandable by the listener in an easy-to-understand manner, with certainty and without an uncomfortable feeling.

In addition, with the above-described the embodiment, the video part of content accompanying video and audio is played back by projecting on a human-shaped screen using the projector 300, so it is possible to playback the content (advertising content and/or the like) to the listener so as to leave a greater impression.

With the above-described the embodiment, the video part of the content accompanying video and audio was played back by projecting on a human-shaped screen using the projector 300, but the present invention is not limited to this, for naturally it is also possible to apply this invention to a form projecting on a regular rectangular screen. In addition, the present invention is not limited to such, for naturally it is possible to apply this invention to a form displaying the video portion on a directly viewed display device.

With the above-described the embodiment, it is possible to also appropriately switch the playback language automatically by detecting whether or not a person is present by a presence sensor 105, and accomplishing a voice recognition process and an image recognition process every predetermined time interval, although such is not described in detail for simplicity.

In addition, with the above-described the embodiment, the content playback control device 100 was explained as being a separate device from the content supply device 200 and the content video playback device 300. However, the content playback control device 100 may also be integrated with the content supply device 200 and/or the content video playback device 300. In such a case, it is possible to make the system even more compact.

Naturally, the present invention can be realized by a content playback control device provided with functions and composition similar to the content playback control device of the above-described embodiments, and by applying a program to an existing content playback control device, it is possible to cause this to function as a content playback control device according to the present invention. In this case, it is possible to cause this to function as a content playback control device according to the present invention by causing a program for realizing the same functions as the above-described content playback control device to be executed on the computer (CPU or other control unit) of a content playback control device provided with the same composition as the content playback control device illustrated in the above-described embodiments. The method of applying such a program is arbitrary, and for example this program can be applied by storing such on a memory medium such as a CD-ROM, memory card or the like, or can be applied via a communications medium such as the Internet or the like.

Besides this, the present invention is not limited to the above-described the embodiment, for various variations are possible without deviating from the scope thereof at the implementation stage. In addition, the functions executed by the above-described the embodiment may be appropriately combined and implemented to the extent possible. Various stages are included in the above-described the embodiment, and it is possible to extract various inventions through appropriate combinations of multiple constituent elements disclosed. For example, even if a number of constituent elements are omitted from all constituent elements shown in the embodiment, as long as the effect can be obtained the composition with those constituent elements removed is extracted as an invention.

This application claims the benefit of Japanese Patent Application No. 2012-147648, filed on Jun. 29, 2012, the entire disclosure of which is incorporated by reference herein.

### REFERENCE SIGNS LIST

100 Content playback control device
101 Communicator
102 Content input device
103 Operator
104 Display device
105 Presence sensor
106 Audio input device
107 Microphone
108 Imager
109 Audio output device
110 Speaker
111 Video output device
112 CPU
113 Power source controller
114 Memory device
200 Server
300 Projector
310 Screen
320 Video projected as content detail

1. A content playback control device for controlling playback of content, comprising:
an acquirer that acquires an attribute of a listener that is the target of providing content;
a determiner that determines a language when playing back the content, based on the attribute of the listener acquired by the acquirer; and
a playback controller that plays back the content through audio in the determined language determined by the determiner.

2. The content playback control device according to claim 1, wherein:
the acquirer includes an audio acquirer that acquires audio from the listener; and
the determiner determines the language when playing back the content based on the audio from the listener as an attribute of the listener acquired by the audio acquirer.

3. The content playback control device according to claim 1, wherein:
the acquirer includes an imager that images the listener; and
the determiner assesses the race and/or nationality as an attribute of the listener based on the image of the listener imaged by the imager, and determines the language when playing back the content based on the assessed race and/or nationality.

4. The content playback control device according to claim 1, further comprising:
a presence sensor that detects whether or not the listener is within a prescribed range;
wherein the acquirer acquires the attribute of the listener when it is detected by the presence sensor that the listener is within a prescribed range.

5. The content playback control device according to claim 1, wherein:
the playback controller includes a retriever that retrieves content corresponding to the determined language; and
when content corresponding to the determined language cannot be retrieved by the retriever, the content is converted to content corresponding to the determined language.

6. The content playback control device according to claim 1, wherein:
the playback controller includes a retriever that retrieves content corresponding to the determined language; and
when content corresponding to the determined language is retrieved by the retriever, the retrieved content is selected as the playback content.

7. The content playback control device according to claim 1, wherein:
the content includes video to be played back along with audio in the determined language; and
the playback controller causes the content to be played back in synchronous with the video.

8. The content playback control device according to claim 7, wherein the playback controller modifies the video to be played back along with the audio in the determined language, and plays back the content in synchronous with the video.

9. The content playback control device according to claim 1, wherein the content playback control device is a projection device comprising a video projector for making a display by projecting the video on a screen.

10. The content playback control device according to claim 1, wherein the content playback control device is a display device comprising a video display device for displaying the video.

11. A content playback control method for controlling playback of content, comprising:
an acquisition step for acquiring an attribute of a listener that is the target of providing content;
a determination step for determining a language when playing back the content, based on the attribute of the listener acquired by the acquisition step; and
a playback control step for playing back the content through audio in the determined language determined by the determination step.

12. A computer-readable non-transitory recording medium that stores a program executed by a computer built into which is a device for controlling playback of content, the program causing the computer to function as:
an acquirer that acquires an attribute of a listener that is the target of providing content;
a determiner that determines a language when playing back the content, based on the attribute of the listener acquired by the acquirer; and
a playback controller that plays back the content through audio in the determined language determined by the determiner.
